(19) United States
(12) Patent Application Publication
(10) Pub. No.: US 2008/0288617 A1
(43) Pub. Date: Nov. 20, 2008

(54) Distributed discovery and network address assignment

(75) Inventors: Michel Gillet, Helsinki (FI); Sergey Balandin, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/798,754

(22) Filed: May 16, 2007

(51) Int. Cl. G06F 15/177

(52) U.S. Cl. 709/222

(57) ABSTRACT

The present invention provides a method for assigning network addresses comprising advertising a type of a device in a network towards neighboring devices, determining the type of at least one device in the network with said advertising, and defining, by the at least one device with the type determined, network addresses for the other devices. Further, the present invention also provides respective devices of the network.

### FIELD OF THE INVENTION

The present invention relates to a method for distributed discovery and network address assignment.

In general, when a network is booted up, every node in the network needs to get a network address. Otherwise a node without network address cannot be reached and is not able to receive any packets.

In a system area network that defines a communication centric network protocol, network addresses are used as destination and/or source of every packet in the network. So all operations, functions and protocols cannot operate before the association of a unique network address for every single device in a network, a sub-network or a cluster is made.

The discovery and network assignment protocols that are used, e.g. in IP (Internet Protocol) networks, are not suitable for system area networks as they have been designed with completely different architecture and limitations in mind.

In the IP case, some protocols like RARP (Reverse Address Resolution Protocol), BOOTP (Boot Protocol) and DHCP (Dynamic Host Configuration Protocol) address the same problem, but they are all designed to fit with the internet architecture and are not suitable for system area networks.

### SUMMARY

The present invention provides a method and entities for distributed discovery and network address assignment.

The invention proposes a discovery mechanism, wherein the discovery mechanism itself is a distributed process, that means that each client/end node, switch or network address manager is active during the discovery phase, e.g. after a reset of a client or a switch, the respective entity sends a message to its neighbour node. The network address manager is a device with special functionality that provides some means to allocate and assign network addresses for clients. Beside that, the network address manager might have other features included e.g. the network address manager might be able to behave like a normal client or include some other control functionality. There is no initiating master necessary. Further, the discovery mechanism supports cyclic and acyclic network topologies, i.e. it is independent of the network topology.

Furthermore, the discovery mechanisms supports the existence of multiple entities that are capable of assigning network addresses, i.e. multiple network address managers, by providing an arbitration mechanism to elect only one single such entity to do the assignment. Such arbitration can be performed at anyone of the nodes in the network or at a dedicated entity. Moreover, the discovery mechanism is reliable regardless of the reliability of the underlying protocol and it supports dynamic addition and removal of nodes to and from the network. Further, the proposed solution is simple and scalable in light of its features and all agents in this protocol can be implemented in hardware.

The assigned network address for each client is selected by the network address manager and therefore there is no need for a predefined unique identification number that has to be defined in each node. Instead, during the discovery procedure the identification of each node is based on the address that is depending on the network path from the network address manager.

According to an aspect of the present invention, there is provided a method for assigning network addresses comprising: advertising a type of a device in a network towards neighboring devices, determining the type of at least one device in the network with said advertising, and defining, by the at least one device with the determined type, network addresses for the other devices.

According to further refinements of the invention as defined under the above aspect
the type of the device being a client, a switch or a network address manager, the network comprising at least one client, any number of switches and at least one network address manager, and the network address manager defining the network address for the at least one client;
the advertising comprising transmitting messages to advertise the at least one client, the switches and the at least one network address manager after a link has been established;
the method further comprises setting ports of a switch for which ports no link is established or no advertisement message is received to a disconnected state;
the method further comprises setting ports of a switch for which ports a link is established and at which another advertisement message than from the network address manager is received to a waiting state;
the method further comprises, in case only a single network address manager is present in the network, setting a port of the switch for which port a link is established and at which an indication that a network address manager is found is received to a state indicating that a network address manager is found;
the indication that a network address manager is found being either an advertisement from the network address manager itself or a message from the switch indicating that a network address manager is found;
the method further comprises storing, at the switch receiving the indication that a network address manager is found, an address of the network address manager and an address of itself, and transmitting a message indicating that a network address manager is found to all ports that are not pointing towards the found network address manager;
the method further comprises at the at least one client receiving the message indicating that a network address manager is found, storing the address of the network address manager and an address of itself, and transmitting an information message to the neighbor device;
the method further comprises setting the ports, at which the information message from the at least one client is received, to a state indicating that a discovery is completed, forwarding the information messages received from all available clients to the network address manager, transmitting a message indicating that the discovery is completed to the network address manager, and allocating network addresses to the at least one client, and transmitting by the network address manager at least a message assigning the allocated network address to the at least one client;
the method further comprises, in case more than one network address manager is present in the network, setting a first port of the switch for which ports a link is established and at which an advertisement from one of the network address managers is first received to a state indicating that a network address manager is found, setting another port of the switch for which port a link is established and at which an advertisement from another one of the network address managers is received to a waiting state, and transmitting a message indicating that a network address manager is found to the network address managers;
the method further comprising an arbitration phase including determining one of the network address managers to act as the network address manager, and determining the another network address managers to act as a client;
the messages comprising a predetermined number of bits indicating the kind of message.

According to a further aspect of the present invention, there is provided a client, comprising a transmitter configured to transmit a message to advertise the client, a receiver configured to receive a message containing a network address allocated to the client, and a memory configured to store said network address.

According to a further aspect of the present invention, there is provided a switch, comprising: a transmitter configured to transmit a message to advertise the switch, a setting unit configured to set ports for which a link is established and at which another advertisement message than from a network address manager is received to a waiting state, the setting unit being further configured to set a port for which a link is established and at which an indication that a network address manager is found is received to a state indicating that a network address manager is found, a storing unit configured to store an address of the network address manager and an address of itself, the transmitter being further configured to transmit a message indicating that a network address manager is found.

According to further refinements of the invention as defined under the above aspect
the setting unit being further configured to set ports, at which information messages from clients are received, to a state indicating that the discovery of the related port is completed, and the transmitter being further configured to forward the information messages to the network address manager and to transmit a message indicating that the discovery is completed to the network address manager
in case more than one network address manager is present in the network, the setting unit being further configured to set a first port of the switch for which ports a link is established and at which an advertisement from one of the network address managers is first received to a state indicating that a network address manager is found, and to set another port of the switch for which port a link is established and at which an advertisement from another one of the network address managers is received to a waiting state, thereby initiating an arbitration phase.

According to a further aspect of the present invention, there is provided a network address manager, comprising: a transmitter configured to transmit a message to advertise itself for network discovery, a receiver configured to receive a message indicating that the discovery is completed, and an allocating unit configured to allocate network addresses for at least one client connected to the network, the transmitter being further configured to transmit a message assigning the allocated network address to the at least one client.

According to further refinements of the invention as defined under the above aspect
the receiver being further configured to receive a message indicating that a network address manager is found, and after an arbitration phase is performed, if the network address manager wins the arbitration, the network address manager being configured to allocate network addresses, and if the network addresses manager loses the arbitration, the network address manager being configured to act as a client;
the receiver being further configured to receive an information message from the at least one client.

A computer program product including a program comprising software code portions for performing, when the program is run on a processing device: advertising a type of a device in a network towards neighboring devices, determining the type of at least one device in the network with said advertising, and defining, by the at least one device with the determined type, network addresses for the other devices.

For the purpose of the present invention to be described herein below, it should be noted that
a client is an addressable node in the network, it may for example be any kind of functional device like a display, camera, graphic processor or modem, such as wireless or wired devices, irrespective of a specific standard to which these conform;
method steps likely to be implemented as (low level) software code portions and being run using a processor at one of the client, switch or manager entities, are software code independent and can be specified using any known or future developed programming language as long as the functionality defined by the method steps is preserved;
generally, any method step is suitable to be implemented as software or by hardware without changing the idea of the present invention in terms of the functionality implemented;
method steps and/or devices likely to be implemented as hardware components at one of the entities (client, switch network address manager, etc.) are hardware independent and can be implemented using any known or future developed hardware technology or any hybrids of these, such as MOS (Metal Oxide Semiconductor), CMOS (Complementary MOS), BiCMOS (Bipolar CMOS), ECL (Emitter Coupled Logic), TTL (Transistor Transistor Logic), etc., using for example ASIC (Application Specific Integrated Circuit) components or DSP (Digital Signal Processor) components, as an example;
devices can be implemented as individual devices, but this does not exclude that they are implemented in a distributed fashion throughout the system, as long as the functionality of the device/system is preserved;
respective elements, e.g. setting unit, allocating unit, etc. according to present embodiments can be implemented by any known means, either in hardware (DSP, microprocessor, microcontroller, ASIC, FPGA, etc) and/or software, respectively, as long as it is adapted to perform the described functions of the respective parts.

### BRIEF DESCRIPTION OF THE DRAWINGS

The present invention is described herein below with reference to the accompanying drawings, wherein:

FIG. 1 is an overview of a network to which embodiments of the present invention are applicable;

FIG. 2 is an overview of a network to which embodiments of the present invention are applicable, the network being in a state after performing discovery;

FIG. 3 is an overview of a network to which embodiments of the present invention are applicable, the network having more than one network address manager;

FIG. 4 shows a flowchart illustrating the transmitting process of a client according to embodiments of the present invention;

FIG. 5 shows a flowchart illustrating the receiving process of a client according to embodiments of the present invention;

FIG. 6 shows a flowchart illustrating the transmitting process of a network address manager according to embodiments of the present invention;

FIG. 7 shows a flowchart illustrating the receiving process of a network address manager according to embodiments of the present invention;

FIGS. 8A and 8B show a flowchart illustrating the transmitting process of a switch according to embodiments of the present invention;

FIG. 9 is an overview for explaining the configuration of the routing table;

FIG. 10 is another overview for explaining the configuration of the routing table.

FIG. 11 is a block diagram showing a network address manager according to embodiments of the present invention.

FIG. 12 is a block diagram showing a switch according to embodiments of the present invention.

FIG. 13 is a block diagram showing a client according to embodiments of the present invention.

FIG. 14 is an overview of a sub-network being added to an existing network according to embodiments of the present invention.

FIG. 15 is an overview in which the existing network is replaced by a virtual network address manager according to embodiments of the present invention.

### DETAILED DESCRIPTION OF EMBODIMENTS OF THE INVENTION

The present invention will be described herein below with reference to the accompanying drawings.

In the following description there will be distinguish between two elements in a network, namely nodes and switches. Further, there are two kinds of nodes, namely clients and network address managers, wherein a client needs a network address (NET_ADDR) and a network address manager (NAM) can assign network addresses.

The protocol which will be described in the following uses different messages. Each kind of nodes and switches uses only a subset of all messages. In the following, all messages are written with capital letters and in bold/italic. The list of messages is as follows:
NAMADV: is sent only by a network address manager to advertise itself; it contains a unique NAM identification number that may be composed of the MID (Manufacturer ID) and a NAM ID (unique ID) as well as an arbitration phase number;
SWITCH: is sent only by a switch to advertise itself and contains the number of ports of the switch;
CLIENT: is sent by a client to advertise itself; optional capability information of the client could be included;
NAMFOUND: is sent only by a switch to inform other switches or clients or a NAM that a NAM has been found; it contains an arbitration phase number, an unique NAM identification number, an address of the network address manager NAM_ADDR, which is the succession of port number to reach the NAM, and an address ADDR, which is the succession of port number to be reached by NAM;
DONE: is sent only by a switch when all sub-networks attached to its ports, excluding the port pointing towards the NAM, have completed the discovery; it contains an arbitration phase number and an address ADDR of the switch sending this message;
INFO: is sent only by a client to send information to the NAM for proper network address (NET_ADDR) allocation; it contains an arbitration phase number, and an address ADDR of the client; optional capability information of the client could be included;
ACK: is sent to acknowledge a message;
SET: is sent to set the NET_ADDR of a client; it contains a NET_ADDR of the node and an address ADDR of the node; optional other control and status information could be included;
RELEASE: is used by a client to indicate to the host that it does not need this NET_ADDR anymore; it contains a NET_ADDR to be released and an address ADDR of the client releasing this NET_ADDR.

All of the above messages are encoded following the same template, i.e. 4 bits are used to identify the kind of message and 4 bits are reserved.

At boot up and after bringing up the link(s), every switch, client and NAM sends a message to advertise itself to his neighbour(s): NAMADV for a NAM, SWITCH for a switch and CLIENT for a client. A switch has at least three ports. To each of them the switch must associate a state which can have the following values:
WAIT: the discovery in the sub-network accessible from this port is not completed;
DONE: the discovery in the sub-network accessible from this port has been completed;
NAMS: a NAM has been found in the sub-network accessible from this port;
DISC: when the port is attached to a link which does not seem to have a peer entity connected to it;
IDLE: state after boot up waiting for link initialization;
CONN: state when the link attached to the port could be initialized.

Every switch has one field ADDR and at least one field NAM_ADDR. Every client has one field ADDR and one field NAM_ADDR. ADDR is the address of a switch or client and NAM_ADDR is the address of a NAM. Additionally every client has a field for his NET_ADDR.

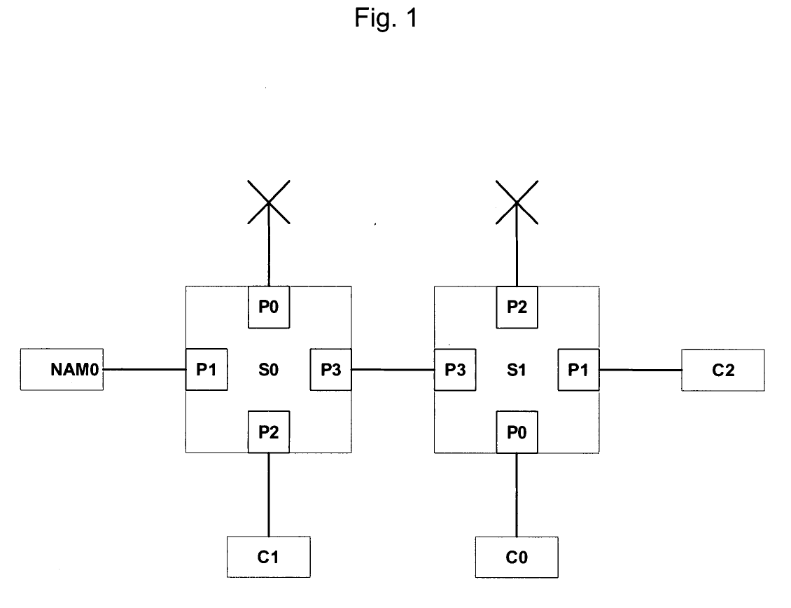

FIG. 1 is an overview of a network to which embodiments of the present invention are applicable. This network is an acyclic network and has one NAM NAM0, two switches S0 and S1, three clients C0, C1 and C2, and two links that are not connected to any node and marked by a black cross.

After boot up, every switch resets the state of each of its ports to IDLE. Every link attempts to establish connection with its peer entity via the responsible protocol layer.

When a link is brought to live, every client, NAM and switch must send its advertisement message on the link.

If a link cannot be brought up to live or no advertisement message is received, the switch considers the link to be disconnected and sets the state of the port to DISC. When a switch receives an advertisement message on one of its ports, it changes the state of the related port to WAIT.

When a switch receives a NAMADV message on a given port, it changes the state of the port to NAMS and sends a massage NAMFOUND to all his ports which are not in a DISC state. Since the switch got a NAMADV message, it knows that the address of the network address manager NAM0 is given by the port from where the message originates, here from port P1 (see FIG. 1). Then, S0 updates its ADDR and the address of the NAM, NAM_ADDR.

Performing the same operations as described above, the switch S1 reacts to the NAMFOUND message and update its internal states. S1 then in turn sends a message NAMFOUND on all its active ports. When a client receives the message NAMFOUND, it updates its internal state as well and sets its ADDR and NAM_ADDR fields accordingly.

The final stage of the first phase is then reached when all clients and switches have updated their internal fields ADDR and NAM_ADDR. As soon as a client receives the message NAMFOUND, it updates its internal fields (NAM_ADDR and ADDR) and has to send the message INFO.

When a switch receives an INFO message on a given port it forwards that INFO message to the port that is in the state NAMS.

When a switch receives a message INFO or DONE on a given port, it knows that the discovery of the sub-network accessible through that port is completed. When a switch has all its ports either in NAMS or DISC or DONE state, it sends a DONE message to the port in the state NAMS.

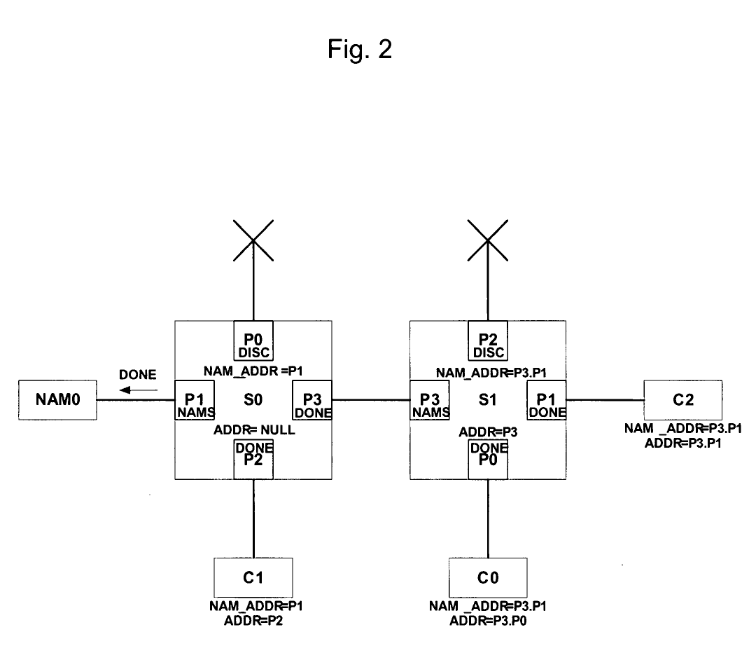

Finally, when the NAM received a DONE or an INFO message knowing that an CLIENT message was received earlier, the NAM knows that there is only one NAM in the network and that it is himself. At this point, the NAM has all the information it needs to allocate the NET_ADDRs. Such a state is shown in FIG. 2.

The allocated NET_ADDRs are assigned to each client by transmitting the SET message.

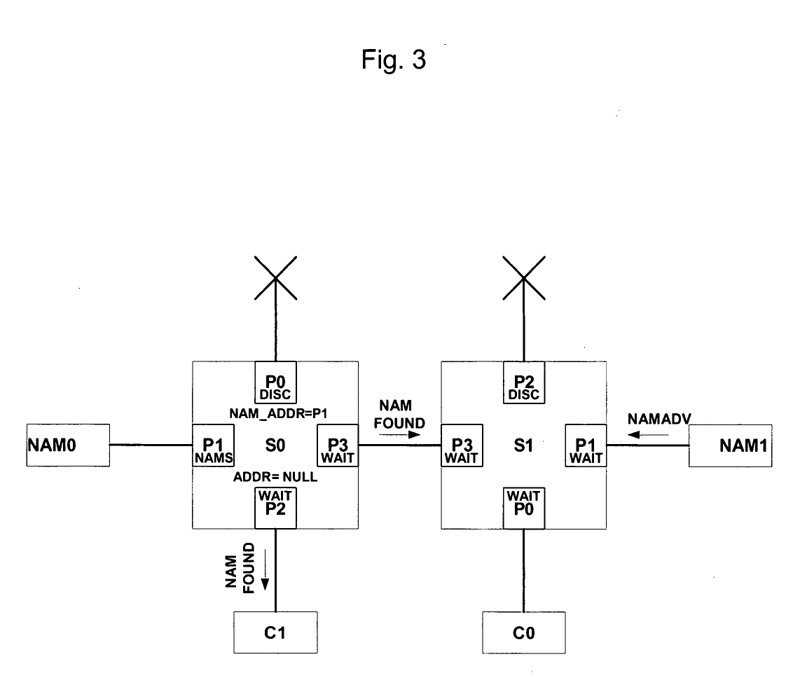

In the above description, it has been assumed that only one NAM is present in the network. However, there might be a case where more than one NAM is present in the network. For illustrating such a case, client C2 in FIG. 2 has been replaced by a NAM NAM1. Except for this change, the sequence of messages is similar and the network is then in the state shown in FIG. 3. At this moment, switch S1 receives two messages from different ports claiming to have found a NAM. Namely, it receives a NAMFOUND message from switch S0 and a NAMADV message from NAM NAM1. However, since it is desirable to achieve uniqueness of the NET_ADDRs in the network, sub-network or cluster, only one NAM should have authority to allocate the NET_ADDRs.

Therefore, an arbitration phase must then be started in order to elect only one NAM in the network, sub-network or cluster. In this case, switch S1 initiates the arbitration phase.

When the switch S1 receives the message NAMFOUND from switch S0, it knows the address of the NAM NAM0, which is P3.P1 in FIG. 3. When switch S1 receives the message NAMADV from NAM NAM1, it knows the address of NAM NAM1, which is P1 in FIG. 3. Switch S1 then sends a NAMFOUND message to NAM NAM1 exactly like if NAM NAM1 was a client and also sends a NAMFOUND message to NAM NAM0.

When a NAM receives a NAMFOUND message, it knows that an arbitration phase has started. A special procedure is then used to elect the NAM. The elected NAM starts again the whole procedure by issuing a NAMADV message. On the other hand, the NAM or NAMs that have lost the arbitration phase are downgraded to a simple client and issue a CLIENT message just after losing the arbitration. Now it is known that the elected NAM is unique in the network, sub-network or cluster, and the same procedure as described above for the case of only one NAM is performed with an updated arbitration phase number.

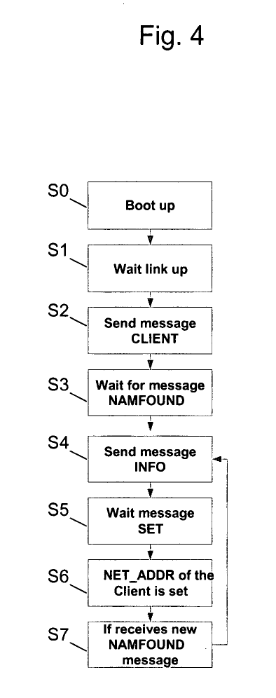

FIG. 4 shows a flowchart illustrating the transmitting process of a client according to embodiments of the present invention.

After the boot up of the client (S0) and after the link has been established (S1), the client sends a CLIENT message to advertise itself (S2). Then, the client waits for a message NAMFOUND indicating that a network address manager in the network has been found (S3). When a NAMFOUND message has been received by the client, it sends an INFO message to the port to which it is connected (S4) and waits for a message SET (S5). After receiving the message SET, the NET_ADDR of the client is set (S6), and in case a new NAMFOUND message is received at the client, the flow gets back to S4 and the client sends again an INFO message.

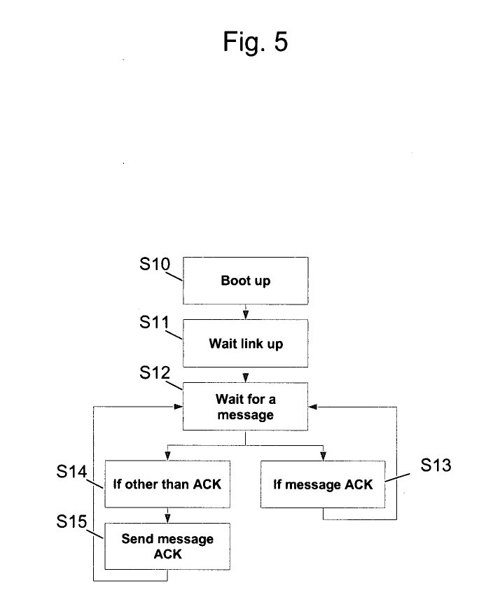

FIG. 5 shows a flowchart illustrating the receiving process of a client according to embodiments of the present invention.

After the boot up of the client (S10) and after the link has been established (S11), the client waits for a message to be received (S12). After receiving a message, it is checked whether the received message is an acknowledgement or not. If the message is an acknowledgement (S13), the process returns to S12 and the client waits for the next message. If the message is not an acknowledgement (S14), the client sends an acknowledgement for this message (S15) and then returns to S12 to wait for the next message.

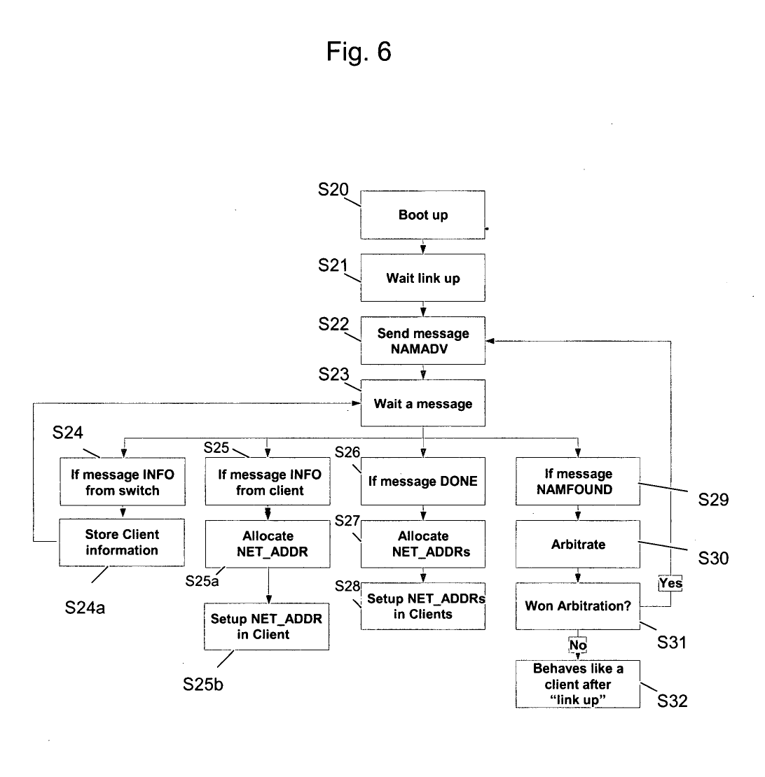

FIG. 6 shows a flowchart illustrating the transmitting process of a network address manager according to embodiments of the present invention.

After the boot up of the NAM (S20) and after the link has been established (S21), the NAM sends a message NAMADV (S22) and then waits for a message to be received (S23). If a received message is an INFO message, it is checked whether it is an INFO message received from a client or a switch. If the INFO message is received from a switch (S24) the NAM stores the information about the respective client originating the INFO message (S24a) and returns to S23 waiting for the next message. If the INFO message is received from a client attached directly to the NAM (S25), the NAM allocates a network address to the client (S25a). Then, the NET_ADDR in the client is set up (S25b) based on the transmission of a SET message that is generated for the client. If the received message is a DONE message (S26), the NAM has all information it needs to allocate the NET_ADDRs and therefore, in S27, allocates the NET_ADDRs. Then, the NET_ADDRs in the clients are set up (S28) based on the transmission of a SET message that is generated for each known client.

However, if the received message is a NAMFOUND message (S29), an arbitration phase will be started (S30). In S31 it is checked whether the NAM has won or lost the arbitration. If the NAM has won the arbitration, the flow returns to S22 and the NAM sends again a NAMADV message to advertise itself. In the case where the NAM has lost the arbitration, the flow proceeds to S32 and the NAM behaves like a client as shown in FIG. 4 and FIG. 5.

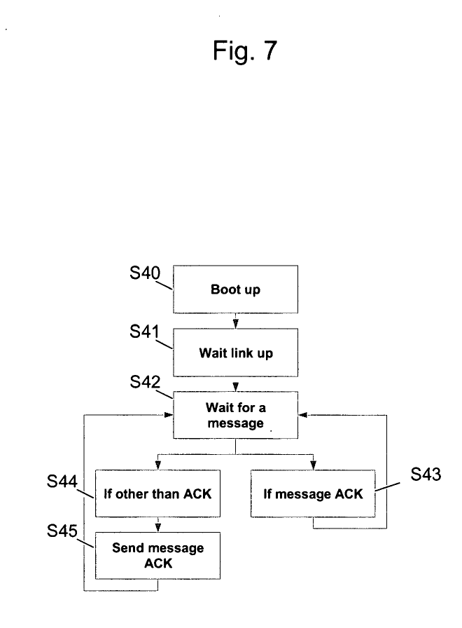

FIG. 7 shows a flowchart illustrating the receiving process of a NAM according to embodiments of the present invention.

The receiving process of a NAM is similar to the receiving process of the client as described above with respect to FIG. 5. After the boot up of the NAM (S40) and after the link has been established (S41), the NAM waits for a message to be received (S42). After receiving a message, it is checked whether the received message is an acknowledgement or not. If the message is an acknowledgement (S43), the process returns to S42 and the NAM waits for the next message. If the message is not an acknowledgement (S44), the NAM sends an acknowledgement for this message (S45) and then returns to S42 to wait for the next message.

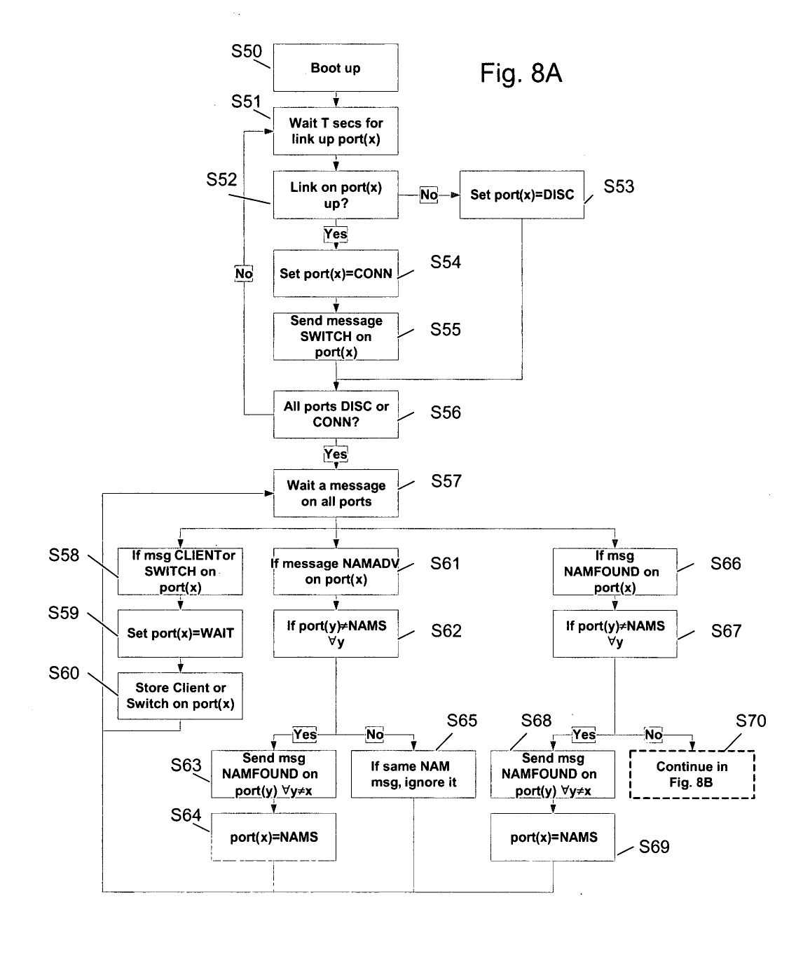

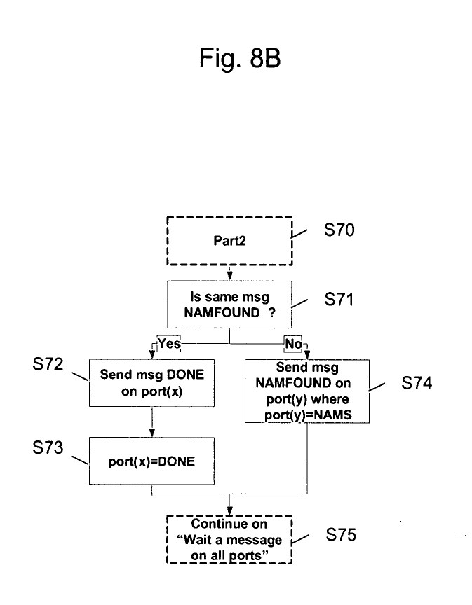

FIGS. 8A and 8B show a flowchart illustrating the transmitting process of a switch according to embodiments of the present invention.

After the boot up (S50), the switch waits for a predetermined period of time for the establishment of a link for every port (S51). Then, it is checked at S52, if the link for every port has been established. If a link for a certain port has not been established, the state of this port is set to DISC (S53). Otherwise, if the link has been established, the state of the port is set to CONN (S54), and a message SWITCH is send from all ports having the state CONN in order to advertise the switch (S55). At S56, it is checked if the state for all ports has been set either to DISC or to CONN. If not all ports have been set into one of these states, the flow returns to S51 to wait for a predetermined period of time. Otherwise, if all ports are in the state DISC or CONN, the flow proceeds to S57 where the switch waits for a message to be received.

If a message received at a port of the switch is a message CLIENT or SWITCH (S58), the switch sets the state of the respective port to WAIT (S59) and stores the client or switch at that port (S60). Then, the flow returns to S57 to wait for the next message to be received.

If a message received at a certain port is a message N V (S61), it is checked if another port of the switch is in a state NAMS (S62). If no other port is in the state NAMS, the switch sends a message NAMFOUND on all ports other than the one that received the NAMADV message (S63), while the state of the port that received the NAMADV message is set to NAMS (S64). Then, the flow returns to S57 to wait for the next message to be received. If another port of the switch is in a state NAMS and it is the same NAMADV message, the message is ignored (S65) and the flow returns to S57 to wait for the next message to be received.

If a message received at a certain port is a message NAMFOUND (S66), it is again checked if another port of the switch is in a state NAMS (S67). If no other port is in the state NAMS, the switch sends a message NAMFOUND on all ports other than the one that received the NAMADV message (S68), while the state of the port that received the NAMADV message is set to NAMS (S69). Then, the flow returns to S57 to wait for the next message to be received.

However, in case another port of the switch is already in a state NAMS, the flow proceeds to step S70, which is illustrated in FIG. 8B.

In S71 of FIG. 8B, it is checked if the received message NAMFOUND is the same message upon which the other port of the switch has been set to NAMS. If it is the same message, the switch sends a message DONE on the port that has received the latest NAMFOUND message (S72) and sets this port to the state DONE (S73). Then, the flow returns to S57 to wait for the next message to be received. If it is determined in step S71 that the received NAMFOUND message is not the same message upon which the other port of the switch has been set to NAMS, a message NAMFOUND is sent on that other port which is in the state NAMS and the flow returns to S57 to wait for the next message to be received.

If all the ports of the switch are either NAMS or DONE, the switch sends a message DONE on the port that is in the state NAMS. At this point, the NAM has all the information it needs to allocate the NET_ADDRs.

Before sending the DONE message on the port that is in the NAMS state the switch should ensure that it has forwarded all received INFO messages on the port that is in the NAMS state. Due to simplicity reason this forwarding mechanism is not presented in the figures.

There might be a scenario where, for example, a switch might receive first a NAMADV, SWITCH or CLIENT message before it has transmitted its advertise message via that port. A similar situation might be possible for the client where first a SWITCH message is received and the CLIENT message is sent afterwards. This might also be possible for the NAM where the NAMADV message is transmitted after the SWITCH message is received. The same might be valid for the NAM. It might first receive the advertise message from his peer node before NAM sends his advertise message.

It is to be noted that all processing steps that have been described in the foregoing can also be implemented using computer-readable signals that may be stored on a computer-readable medium and carry instructions to be executed by one of the devices.

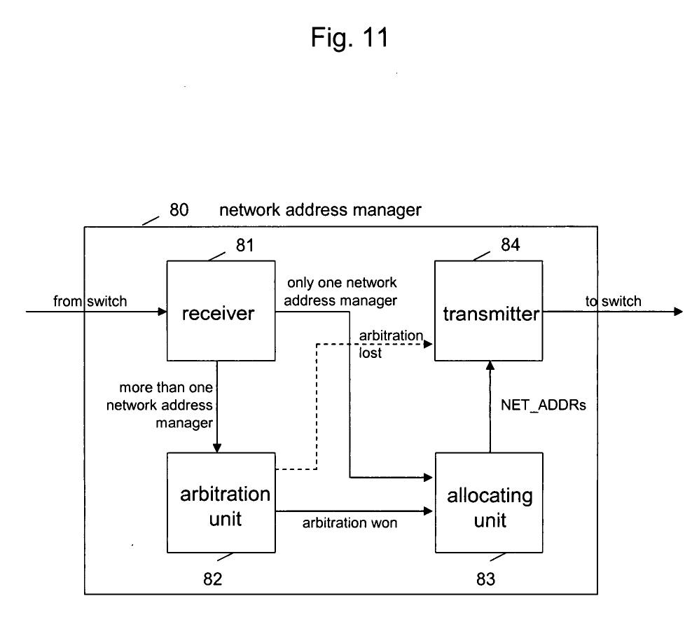

FIG. 11 is a block diagram showing a network address manager according to embodiments of the present invention. A network address manager 80 according to embodiments of the present invention comprises a receiver 81 for receiving messages from the switches. Further, the network address manager comprises a transmitter 84 for transmitting messages to the switches, e.g. to advertise itself. The receiver 81 is connected to an allocating unit 83. In case there is only one network address manager and the receiver 81 receives a DONE message, the receiver 81 informs an allocating unit 83 about the DONE message. The allocating unit 83 then allocates NET_ADDRs to the devices in the network via the transmitter 84. Further, as an option, the network address manager may comprise an arbitration unit 82. In case there is more than one network address manager in the network, and the receiver 81 receives a NAMFOUND message, the arbitration unit 82 is informed, which performs the arbitration phase. However, it is to be noted that the network address manager does not necessarily comprise the arbitration unit 82, but that the arbitration can also be performed at any other node in the network or at a dedicated entity. In such a case, the network address manager may receive the result of the arbitration via the receiver 81. If the arbitration is won, the allocating unit 83 is informed, which then allocates NET_ADDRs to the devices in the network via the transmitter 84. If the arbitration is lost, the transmitter acts like a client and sends a CLIENT message to the switch. The network address manager further comprises a storage for storing information received from the switches, which is not shown in FIG. 11.

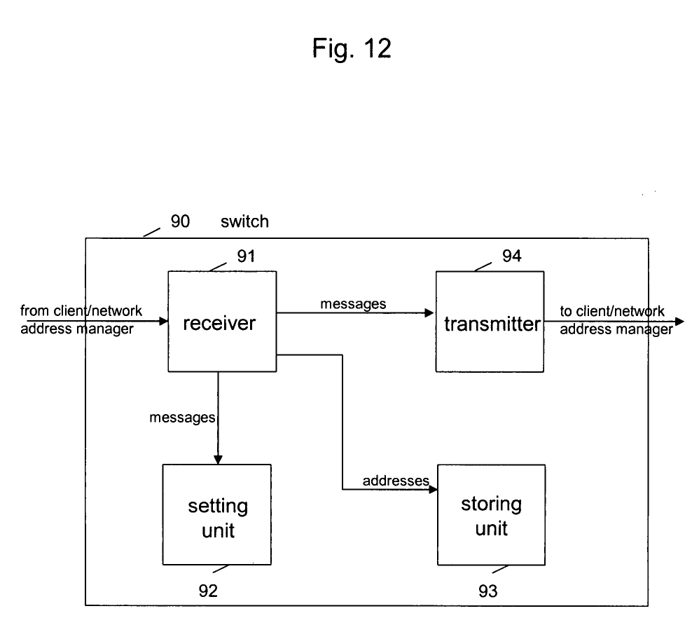

FIG. 12 is a block diagram showing a switch according to embodiments of the present invention. A switch 90 according to embodiments of the present invention comprises a receiver 91 for receiving messages from the clients and the network address managers. Further, the switch 90 comprises a transmitter 94 for transmitting messages to the clients and the network address managers. According to the messages received by the receiver 91, a setting unit 92 sets the ports of the switch. Addresses allocated from the network address manager and the address of the network address manager itself are stored in a storing unit 93.

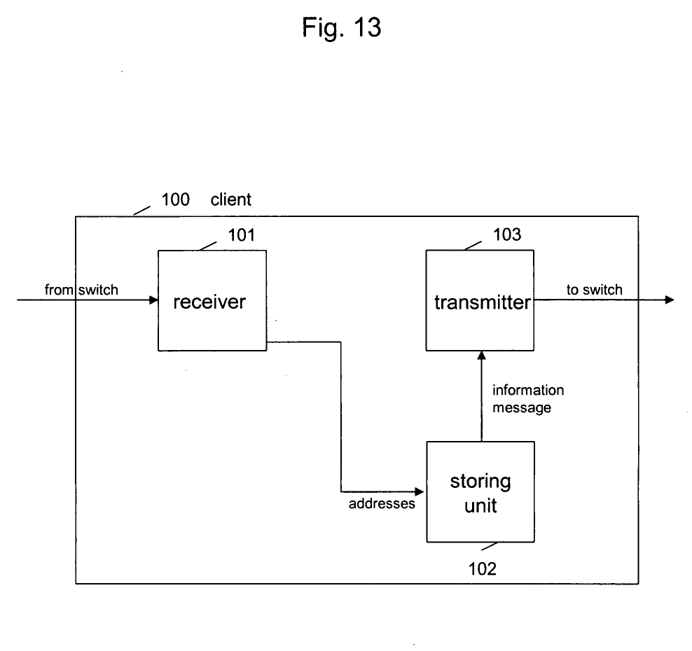

FIG. 13 is a block diagram showing a client according to embodiments of the present invention. A client 100 according to embodiments of the present invention comprises a receiver 101 for receiving messages from a switch and a storing unit 102 for storing an address allocated from the network address manager. Further, the client comprises a transmitter 103 for transmitting messages to the switch, e.g. an information message containing information about the client itself retrieved from the storing unit 102.

The processing of all components comprised in the client, network address manager and switch is either controlled by a central processing unit (CPU) or by separate processing units, respectively, e.g. DSPs or the like, that are not shown in FIGS. 11 to 13.

In the foregoing description of the client, NAM and switch, only the units that are relevant for understanding the principles of the invention have been described using functional blocks. The client, NAM and switch may comprise further units that are necessary for their operation as client, switch and NAM, respectively. However, a description of these units is omitted in this specification. The arrangement of the functional blocks of the network devices is not construed to limit the invention, and the functions may be performed by one block or further split into sub-blocks.

The foregoing description refers to an acyclic network topology. However, the present invention is also applicable to cyclic topologies.

In the case of cyclic topologies, the following three additional issues have to be taken into account as compared to the acyclic case: (1) duplicated NAMFOUND messages originating by the same NAM; (2) NAMFOUND messages originating by two different NAMS; and (3) how to make a distinction between the above mentioned cases.

To solve this issue, NAMFOUND messages sent by one NAM must be uniquely identifiable as belonging to the originating NAM. For example, one simple way to achieve it is to have a unique identification number for every NAM. But there has also to be introduced the concept of the arbitration phase. Thus, every arbitration phase must also be unique and every single NAMFOUND message must be associated to a given arbitration phase. By combining the unique way to identify a NAM and the arbitration phase number, NAMFOUND messages can be uniquely distinguished.

If a switch receives another NAMFOUND message originating from the same NAM and part of the same phase but on a different port, it does not forward it, but send a DONE message on the latest port and change the state of that port to DONE. If another NAMFOUND message originates from the same NAM, but from a different arbitration phase, this message is taken into account and forwarded as usual. If a switch receives two NAMFOUND messages coming from different NAMs, the same arbitration is done between the NAMs as described earlier.

It is to be noted here, that only the NAMs need to have a unique number, nobody else in the network does need it for discovery at least.

Next, the addition of a node or a sub-network to the existing network will be described. As mentioned above, some ports of a switch could be in DISC state if the link could not be initialized. This means that no device was connected to the switch on this port. If at a point in time after the NET_ADDRs have be assigned, a new device is connected or powered up on one of these links, it sends its advertisement message.

In that case the switch could be configured to react in two different modes. Either it is reacting in a secured mode or an unsecured mode. In the unsecured mode a switch would react as it is described above. In that case the complete topology would be announced to the attached parts.

If the switch is configured to react in the secured mode, the current network would behave as a virtual NAM. In that case, when the switch notices that the link is becoming active and receives the advertisement message, the switch handles the advertisement message in a way as described above, but uses the NET_ADDR of the NAM to send it.

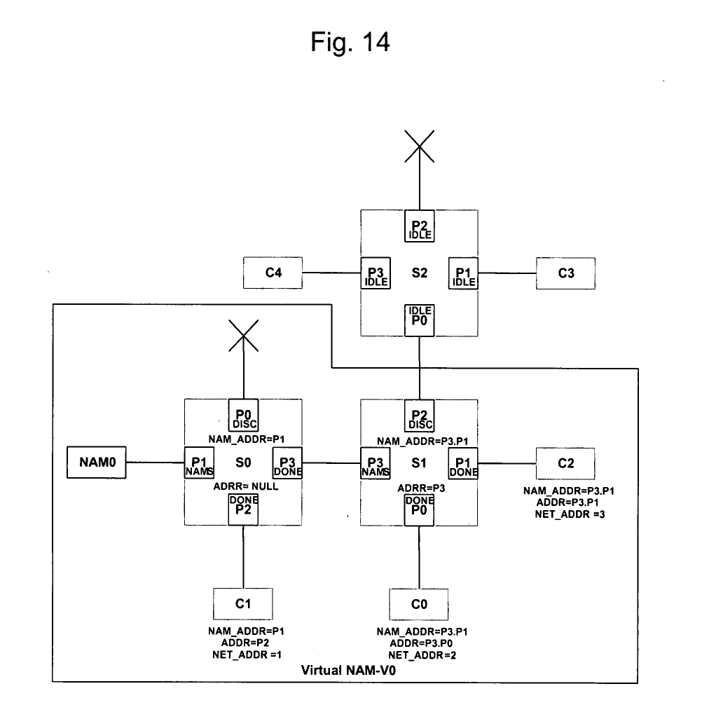

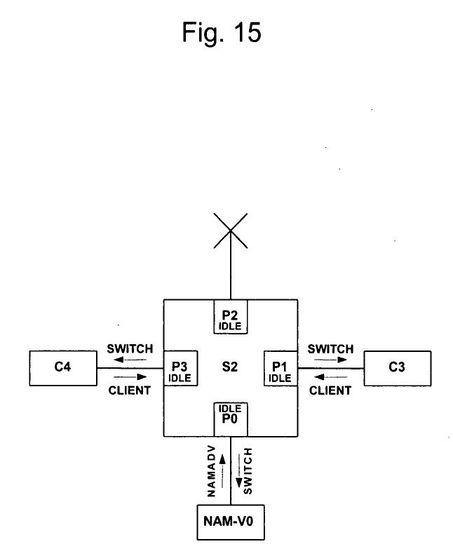

FIG. 14 shows a case in which a network comprising a switch S2 and clients C3 and C4 is added to the existing network as described above. Here, the already existing network is replaced by a virtual network address manager NAM-V0, which case is shown in FIG. 15. Then, the virtual NAM-V0 advertises itself as a network address manager, as illustrated in FIG. 15 and the addresses of the clients C3, C4 and the switch S2 will be determined relative to the NAM-V0, i.e. the switch S1. Thus, the address of the client C4 is P3 and the NAM_ADDR known to client C4 is P0. Further, the address of the switch S2 is NULL and the address of the client C3 is P1.

By doing this, the NET_ADDRs already set earlier will not be affected in anyway. If a NAM is present in the dynamically added sub-network, this NAM will loose automatically the arbitration since the existing NAM has setup the existing network.

According to another option, the NAM-V0 advertises itself as a switch, which exposes the topology of the already existing network. However, in some cases this might be desirable. In this case, the addresses of the switch S2 and the clients C3, C4 will be relative to the network address manager NAM0.

Also, the switch sends the NAMFOUND message to the newly added node or sub-network. In other words, this switch will then just be a “relay” or gateway for the NAM. It means that the NAM handles effectively the addition to the network as a sub-network. The NAM will use a new arbitration phase and the whole procedure as described above is applied only to this additional sub-network with this switch playing the role of a relay.

On the other hand, there may also be a case in which a node or a sub-network is removed from the network. In such a case, since NET_ADDRs are a scarce resource, a special message send to the NAM by a device owning a NET_ADDR to make it available again when leaving the network could be defined. This is achieved by the RELEASE message.

In the following, flow control and reliability of the protocol will be described. This protocol uses messages sent over a link to reach the peer node on the link. It is important that all messages are received correctly or it may endanger the integrity of the system. This protocol has been designed to support both reliable and unreliable links.

In case of reliable links, nothing has to be done than controlling the flow of messages towards the NAM to avoid overflowing its incoming buffer. The flow control uses a single acknowledgement for every single message. Only when a message is acknowledged a new message will be sent.

In case of unreliable links, every message is also acknowledged. If one message is not acknowledged within a certain time period, the message will be retransmitted.

However, there might also be a case that an acknowledgement is lost. In this case after a certain time, the original message will be retransmitted. The receiver could then receive correctly twice the same message, which is handled as follows:
If the same NAMADV message is received twice, it will have the same arbitration phase number and the second occurrence of this message will be ignored;
If the same SWITCH or CLIENT message is received twice, it will not have any other bad effect than repeating the information already sent to adjacent node or switch; those messages have only a local point-to-point meaning;
If the same NAMFOUND message is received twice, it will have the same arbitration phase number and the same origin and will be ignored;
If the same DONE message is received twice, it will have the same arbitration phase number and will be ignored;
If the same INFO message is received twice, it will have the same arbitration phase number and will be ignored;
If the same SET message is received twice, the same NET_ADDR will be assigned twice to the same client, which is not an issue.

As it has been described above, the proposed protocol retransmits a message if after a given time this message has not been acknowledged. However, for nodes it does not require allocation of an additional buffer space for storing the message(s) since every single one of them can be regenerated from the state space of the protocol entity itself. In other words, there is no need of any additional buffering in the nodes to ensure reliable communication of messages by replaying them.

A switch, however, should be able to store one message per input port. Thereby, it is assured that at least one message sent on a link will be stored in the switch. Only when a message received from an input port is acknowledged, another one will be sent.

Next, a configuration of the routing tables will be described. Since all SET messages will pass through all switches, the configuration of the routing tables is done autonomously by every switch by looking at the content of the SET messages. In the case of cyclic network, this will set a default acyclic overlay network on top of the cyclic network.

To discuss this issue further, acyclic and cyclic topologies have to be considered separately. Further, the cyclic topologies have to be divided in three subclasses: (1) with static routing; (2) with semi-static-routing; and (3) with dynamic routing.

In case of acyclic topologies, the basic principle is to have a controlled flooding of the SET messages in the network. When a switch receives a SET message, it will forward it to all others ports which are not in a DISC state. The switch will also compare the address of the client in the SET message to its own address.

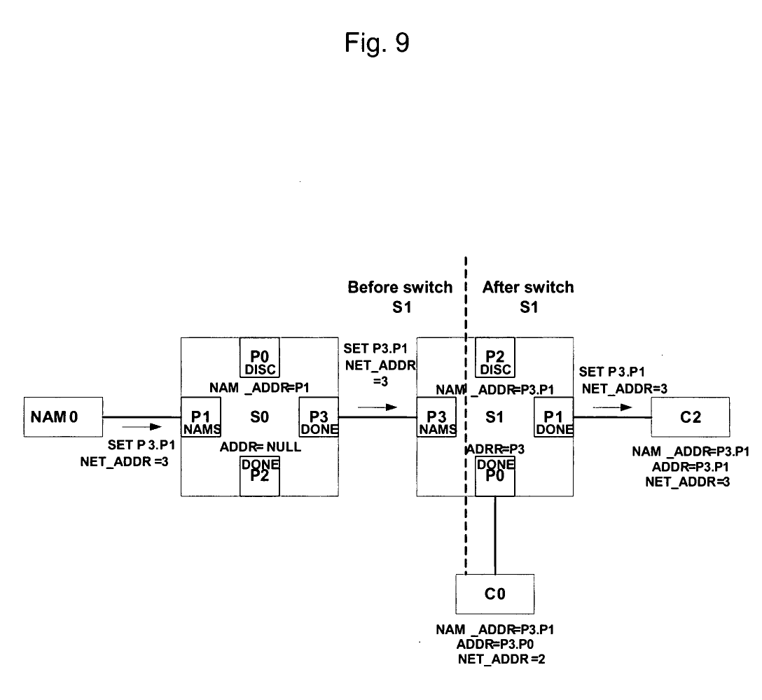

If the address of the switch is a prefix of the address of the client, it means that the client is after the switch relative to the SET message. The routing table should be configured so that for the NET_ADDR stored in the SET message, the output port is the port following the address of the switch in the client address in the SET message. As shown in FIG. 9, when the switch S1 receives the SET message (P3.P1; NET_ADDR=3), the switch will configure in the routing table at the entry of NET_ADDR 3, output port P1. Indeed, the address of the switch is P3, which is a prefix of the client address, so the client is after the switch and the port following the address of the switch is P1.

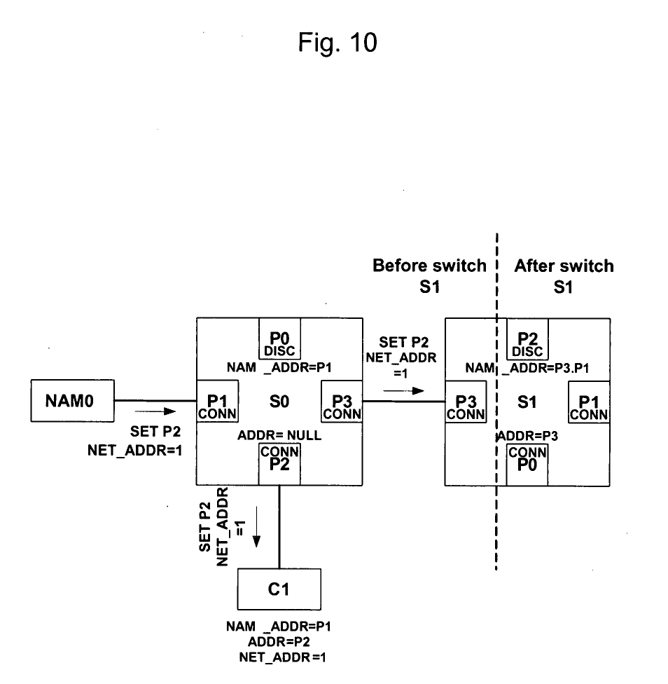

If the address of the switch is not a prefix of the address of the client, it means that the client is before the switch relative to the SET message. The routing table should be configured in a way that at the entry for the NET_ADDR in the SET message, the output port is the port from which the SET message came. As shown in FIG. 10, when the switch S1 receives the SET message (P2; NET_ADDR=1), the entry in the routing table will associate the NET_ADDR 1 to the port P3.

In the case of cyclic topologies with static routing, the same as for acyclic topologies applies here as well, but there are some additions. The main difference is that a switch could see more than once a SET message with the same NET_ADDR. In this case, there are two possibilities.

Firstly, the second SET message is a genuine copy of the original one, which was created because of the presence of a loop and the fact that a flooding mechanism is used to propagate the SET messages, so the arbitration phase number is identical to the original SET message.

Secondly, it is a SET message from a different arbitration phase and coming from the same NAM. It cannot come from a different NAM since SET messages are sent only after the arbitration phase is completed. This fact explains why the SET message does not have a arbitration phase number field.

If the SET message is a genuine copy and the message comes from the same port, the message is ignored. To know if the message comes from the same port, the switch just need to compute what would be the output port for the NET_ADDR. If the result is identical to the value already in the routing table, the message came from the same port and the SET message is simply ignored.

If the message comes from a different port, then an algorithm is started to decide which port should be used to root a packet with this NET_ADDR.

If the SET message was sent in a different arbitration phase, this message will be considered as the first one the switch saw for this NET_ADDR.

This protocol is defined on that way that it is not needed to have any information about the routing scheme. Further the protocol could provide a default acyclic overlay network on top of a cyclic network topology.

In the following, an example of an arbitration protocol will be described. There is a plurality of mechanisms and protocols to arbitrate the access to a shared resource by several users. Any of these mechanism or protocols could be used in this context to define the procedure used by the network address managers in the network to elect a single NAM.

First of all, there are two different classes of solutions. Firstly, centralized solutions, where the decision is made in a centralized controlling entity and the decision is then given to all the network address managers. And secondly, distributed solutions, where every NAM makes its own decision, but globally all network address managers in the network would end up making the same decision.

A distributed solution would be to elect the NAM with the smaller (or higher) numeric value of its unique NAM ID.

For this solution, no additional message has to be defined. The switch should simply let the NAMFOUND message reach all the network address managers. Any NAM will be able to see which NAM has the smallest (or highest) unique NAM ID by simply receiving all this messages.

Next, packet and message encoding will be described. The defined messages might be transmitted on a wire by using a dedicated communication protocol. The shown messages might be encoded in a given protocol data unit by using type definitions. Additionally parameter fields might be added for each message where it is required. The messages would be encoded in any kind of representation that might be understood by the communication partner.

In the above embodiments at least a switch is always presented, however, it is to be noted that the present protocol is also applicable if no switch is present. In such a case, the client might be directly connected to the network address manager. Further, it is described that the arbitration is done in the network address manager but it is to be noted that the arbitration can be done in any other part of the network or even in a dedicated entity with that functionality.

In view of the foregoing description it will be evident to a person skilled in the art that various modifications may be made within the scope of the invention.

1. A method for assigning network addresses comprising:
advertising a type of a device in a network towards neighboring devices,
determining the type of at least one device in the network with said advertising, and
defining, by the at least one device with the determined type, network addresses for the other devices.

2. The method according to claim 1,
the type of the device being a client, a switch or a network address manager, the network comprising at least one client, any number of switches and at least one network address manager, and the network address manager defining the network address for the at least one client.

3. The method according to claim 2, the advertising comprising
transmitting messages to advertise the at least one client, the switches and the at least one network address manager after a link has been established.

4. The method according to claim 3, further comprising
setting ports of a switch for which ports no link is established or no advertisement message is received to a disconnected state.

5. The method according to claim 3, further comprising
setting ports of a switch for which ports a link is established and at which another advertisement message than from the network address manager is received to a waiting state.

6. The method according to claim 3, further comprising
in case only a single network address manager is present in the network, setting a port of the switch for which port a link is established and at which an indication that a network address manager is found is received to a state indicating that a network address manager is found.

7. The method according to claim 6,
the indication that a network address manager is found being either an advertisement from the network address manager itself or a message from the switch indicating that a network address manager is found.

8. The method according to claim 6, further comprising
storing, at the switch receiving the indication that a network address manager is found, an address of the network address manager and an address of itself, and
transmitting a message indicating that a network address manager is found to all ports that are not pointing towards the found network address manager.

9. The method according to claim 8, further comprising at the at least one client receiving the message indicating that a network address manager is found,
storing the address of the network address manager and an address of itself, and
transmitting an information message to the neighbor device.

10. The method according to claim 9, further comprising
setting the ports, at which the information message from the at least one client is received, to a state indicating that a discovery is completed,
forwarding the information messages received from all available clients to the network address manager,
transmitting a message indicating that the discovery is completed to the network address manager, and
allocating network addresses to the at least one client, and
transmitting by the network address manager at least a message assigning the allocated network address to the at least one client.

11. The method according to claim 3, further comprising
in case more than one network address manager is present in the network, setting a first port of the switch for which ports a link is established and at which an advertisement from one of the network address managers is first received to a state indicating that a network address manager is found,
setting another port of the switch for which port a link is established and at which an advertisement from another one of the network address managers is received to a waiting state, and
transmitting a message indicating that a network address manager is found to the network address managers.

12. The method according to claim 11, further comprising an arbitration phase including
determining one of the network address managers to act as the network address manager, and
determining the another network address managers to act as a client.

13. A method according to claim 3, the messages comprising a predetermined number of bits indicating the kind of message.

14. A client, comprising
a transmitter configured to transmit a message to advertise the client,
a receiver configured to receive a message containing a network address assigned to the client, and
a memory configured to store said network address.

15. A switch, comprising:
a transmitter configured to transmit a message to advertise the switch;
a setting unit configured to set ports for which a link is established and at which another advertisement message than from a network address manager is received to a waiting state,
the setting unit being further configured to set a port for which a link is established and at which an indication that a network address manager is found is received to a state indicating that a network address manager is found,
a storing unit configured to store an address of the network address manager and an address of itself,
the transmitter being further configured to transmit a message indicating that a network address manager is found.

16. A switch according to claim 15,
the setting unit being further configured to set ports, at which information messages from clients are received, to a state indicating that the discovery of the related port is completed, and
the transmitter being further configured to forward the information messages to the network address manager and to transmit a message indicating that the discovery is completed to the network address manager.

17. A switch according to claim 16,
in case more than one network address manager is present in the network,
the setting unit being further configured to set a first port of the switch for which ports a link is established and at which an advertisement from one of the network address managers is first received to a state indicating that a network address manager is found, and
to set another port of the switch for which port a link is established and at which an advertisement from another one of the network address managers is received to a waiting state, thereby initiating an arbitration phase.

18. A network address manager, comprising:
a transmitter configured to transmit a message to advertise itself for network discovery,
a receiver configured to receive a message indicating that the discovery is completed, and
an allocating unit configured to allocate network addresses for at least one client connected to the network,
the transmitter being further configured to transmit a message assigning the allocated network address to the at least one client.

19. The network address manager according to claim 18,
the receiver being further configured to receive a message indicating that a network address manager is found,
and after an arbitration phase is performed
if the network address manager wins the arbitration, the network address manager being configured to allocate network addresses, and
if the network addresses manager loses the arbitration, the network address manager being configured to act as a client.

20. The network address manager according to claim 18,
the receiver being further configured to receive an information message from the at least one client.

21. A client, comprising:
transmitter means for transmitting a message to advertise the client,
receiver means for receiving a message containing a network address allocated to the client, and
memory means for storing the network address assigned to the client.

22. A switch, comprising:
transmitter means for transmitting a message to advertise the switch;
setting means for setting ports for which a link is established and at which another advertisement message than from a network address manager is received to a waiting state,
the setting means further for setting a port for which a link is established and at which an indication that a network address manager is found is received to a state indicating that a network address manager is found,
storing means for storing an address of the network address manager and an address of itself,
the transmitter means further for transmitting a message indicating that a network address manager is found,
the setting means further for setting ports, at which information messages from clients are received, to a state indicating that the discovery of the related port is completed, and
the transmitter means further for forwarding the information messages to the network address manager and to transmit a message indicating that the discovery is completed to the network address manager.

23. A network address manager, comprising:
transmitter means for transmitting a message to advertise itself,
receiver means for receiving a message indicating that a discovery is completed, and
allocating means for allocating network addresses for at least one client connected to the network address manager,
the transmitter means further for transmitting a message assigning the allocated network address to the at least one client.

24. A computer program product including a program comprising software code portions for performing, when the program is run on a processing device:
advertising a type of a device in a network towards neighboring devices,
determining the type of at least one device in the network with said advertising, and
defining, by the at least one device with the determined type, network addresses for the other devices.
